(19) United States
(12) Patent Application Publication
(10) Pub. No.: US 2023/0115144 A1
(43) Pub. Date: Apr. 13, 2023

(54) INFORMATION HANDLING SYSTEM AND DISPLAY MONITOR CAMERA WITH ADJUSTABLE TILT COVERAGE MIRROR

(71) Applicant: Dell Products L.P., Round Rock, TX (US)

(72) Inventors: Chih-Hao Kao, Luzhou District (TW); Ghee Beng Ooi, Singapore (SG); Karthikeyan Krishnakumar, Austin, TX (US); Lai Say Poh, Singapore (SG); Sheikh Shohrab, Singapore (SG)

(73) Assignee: Dell Products L.P., Round Rock, TX (US)

(21) Appl. No.: 17/497,370

(22) Filed: Oct. 8, 2021

(51) Int. Cl. H04N 5/225

(52) U.S. Cl. CPC H04N 5/2254; H04N 5/2257

(57) ABSTRACT

An information handling system peripheral display integrates a camera module aligned to capture visual images along an axis parallel to the display panel and directed towards a mirror that rotates out from the display at an angle that reflects light from a front face of the display towards the camera module and rotates down against the display to block external light from entering the camera module. In one embodiment, plural lenses couple to the display to selectively intercede with light that reflects at the mirror to adjust visual images captured by the camera module, such as for a zoom or wide field of view.

### BACKGROUND OF THE INVENTION

### Field of the Invention

The present invention relates in general to the field of information handling system cameras, and more particularly to an information handling system and display monitor camera with adjustable tilt coverage mirror.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Generally, information handling systems are configured as stationary and portable systems. Stationary information handling systems, such as desktops, towers and servers, have housing designed to operate in a fixed location, typically with peripheral input/output devices. Portable information handling systems integrate processing components, a display and a power source in a portable housing to support mobile operations. Portable information handling systems come in a variety of form factors. Tablet configurations typically expose a touchscreen display on a planar housing that both outputs information as visual images and accepts inputs as touches. Larger tablets are sometimes coupled to a display stand and used as all-in-one desktop systems supported by a peripheral keyboard. Convertible configurations typically include multiple separate housing portions that couple to each other so that the system converts between closed and open positions. For example, a main housing portion integrates processing components and a keyboard and rotationally couples with hinges to a lid housing portion that integrates a display. In a clamshell position, the lid housing portion rotates approximately ninety degrees to a raised position above the main housing portion so that an end user can type inputs while viewing the display. After usage, convertible information handling systems rotate the lid housing portion over the main housing portion to protect the keyboard and display, thus reducing the system footprint for improved storage and mobility. Although portable information handling system typically integrate a display, end users often interface with peripheral displays to increase the viewing area supported by the system.

One common peripheral used with information handling systems is a camera, such as to support videoconferencing. Typically, peripheral cameras couple with a clip or bracket to a top side of a peripheral display so that an end user viewing the display will appear to be looking at the camera. Some displays integrate cameras in the display housing, including portable information handling systems, which often integrate a display to capture visual images through an opening in the housing bezel. One difficulty with integration of a camera in a display is that the display typically has a thin housing that lacks sufficient room for a high quality camera or to support tilt and pan of the camera field of view. As a result, end users tend to have to center their face in a certain area during a videoconference so that the camera can capture a reasonable visual image. Some stands and portable information handling systems allow changes in the rotational orientation of the display that support some tilt of a fixed camera, however, tilting the entire display to adjust the camera field of view can degrade the image quality presented at the display. Further, the thin profile of typical display housings prevents movement of the camera lens, such as to support zoom with a telescopic lens.

### SUMMARY OF THE INVENTION

Therefore, a need has arisen for a system and method which provide a camera adjustable field of view.

In accordance with the present invention, a system and method are provided which substantially reduce the disadvantages and problems associated with previous methods and systems to adjust a camera field of view for visual images captured from an information handling system display. A display having a camera module disposed in the display housing interior captures visual images by raising a mirror at an angle relative to the front of the display to reflect light into the camera module.

More specifically, an information handling system processes information with a processor and memory for presentation as visual images at display. The display has an adjustable mirror rotationally coupled to at a top side of the display housing to rotate about an axis at the display housing rear side to a raised inclined position above an opening that exposes light reflected by the mirror to a camera module residing in the display housing interior. A field of view of the camera module adjusts by changing the tilt angle of the adjustable mirror, such as with an end user manual adjustment or by an actuator that is controlled to maintain a visual image in a defined position of the camera field of view, such as facial recognition that centers an end user face in the field of view by actuating the mirror to adjust the field of view. In one example embodiment, selectable lenses are disposed between the mirror and camera module to adjust visual images captured by the camera module, such as a zoom by a telescopic lens. The adjustable mirror closes over the camera module to block external light from entering the camera module when the camera is not in use.

The present invention provides a number of important technical advantages. One example of an important technical advantage is that a camera integrates in a display housing with a minimal footprint and provides an adjustable field of view by changing the tilt angle of an adjustable mirror. Telescopic zoom lenses interface with the camera without increasing the camera or display housing footprint. The adjustable mirror closes against the display housing top side to hide when not in use and to block the camera from capturing visual images when not in use, thus improving system security.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an information handling system interfaced with a peripheral display having an adjustable mirror to direct light towards an integrated camera module;

FIGS. 2A and 2B depict an example of selectable fields of view provided by the adjustable mirror;

FIG. 3 depicts a flow diagram of process for automated selection of a field of view with an actuator coupled to the adjustable mirror;

FIG. 4 depicts a flow diagram of a process for initiation of camera use by opening the adjustable mirror;

FIG. 5 depicts a flow diagram of a process for securing the camera by closing the adjustable mirror;

FIG. 6 depicts an example embodiment of a camera having selectable lenses to adjust light that passes to the camera module; and

FIGS. 7A, 7B and 7C depict alternative embodiments for adjusting light directed to a camera by selectable lens that couple to the display proximate the mirror.

### DETAILED DESCRIPTION

An information handling system display has a mirror that extends out from the display housing to reflect light towards a camera module disposed in the housing at adjustable tilt angles to manage the camera module field of view. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

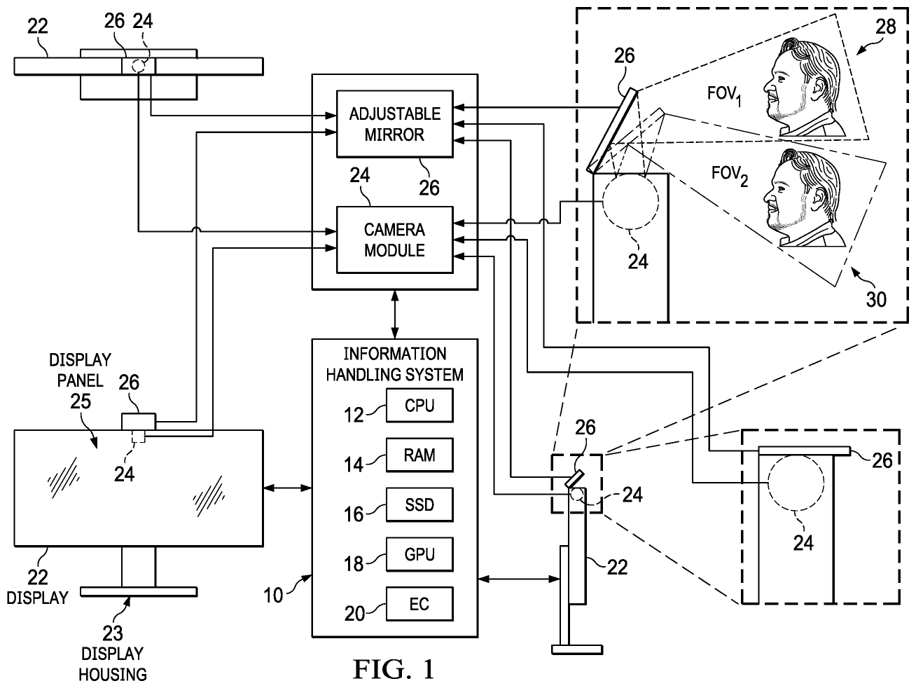

Referring now to FIG. 1, an information handling system 10 interfaces with a peripheral display 22 having an adjustable mirror 26 to direct light towards an integrated camera module 24. In the example embodiment, information handling system 10 has a desktop configuration that presents visual images at display 22 as a separate peripheral. In alternative embodiments, information handling system 10 may have a portable configuration that integrates display 22 in a common housing, such as with a convertible or table configuration. Information handling system 10 process information with a central processing unit (CPU) 12 that executes instructions to process the information in cooperation with a random access memory (RAM) 14 that stores the instructions and information. A solid state drive (SSD) 16 or other persistent storage device provides non-transitory storage of the instructions and information. For example, SSD 16 stores an operating system and applications that are retrieved to RAM 14 at power up to execute on CPU 12. A graphics processing unit (GPU) 18 interfaces with CPU 12 to further process the information and define visual images for presentation at display 22, such as by defining pixel values that are communicated to display 22 through a graphics cable. An embedded controller 20 interfaces with CPU 12 to manage operating conditions within information handling system 10, such as application of power and maintaining thermal constraints, and to manage interactions with input/output devices and peripheral devices.

In the example embodiment, display 22 has a peripheral configuration with a display housing 23 that holds a display panel 25 in a raised vertical orientation so that an end user views the displayed image in a plane substantially perpendicular to the end user's view axis. To capture visual images of the end user, display 22 includes a camera module 24 in the interior of display housing 23 and oriented to capture visual images along a vertical axis with light reflected from an adjustable mirror 26 that extends from the top side of display housing 23. For instance, adjustable mirror 26 rotates about an axis at the rear side of display housing 23 between closed and open positions over an opening in which camera module 24 resides. In the closed position, adjustable mirror 26 blocks external light from reaching camera module 24, thus offering security against unauthorized access of visual images captured by camera module 24. In one embodiment, movement of adjustable mirror 26 to the closed position may power down camera module 24, such as by sensing the closed position with a switch or the lack of external light with an ambient light sensor. In the open position, adjustable mirror 26 varies the angle at which it tilts relative to the plane of display panel 25 to adjust the field of view captured by camera module 24. In the example embodiment a first field of view 28 is depicted at a first tilt angle of adjustable mirror 26 where an end user is at a raised position relative to display 22, and a second field of view 30 is depicted at a second tilt angle of adjustable mirror 26 where an end user is at a lower position. Adjustable mirror 26 provides different fields of view with a manual adjustment by the end user of the mirror tilt angle or, alternatively, with an actuator that automatically adjusts the tilt angle to maintain a desired visual image, such as a face recognized by the camera or an application executing on information handling system 10. For instance, embedded controller 20 executes firmware instructions stored in non-transitory memory that actuate adjustable mirror 26 with commands to a step motor, solenoid or other actuator coupled to adjustable mirror 26. Alternatively, camera module 24 includes a processing element that executes firmware stored in non-transitory memory to manage the tilt angle of adjustable mirror 26.

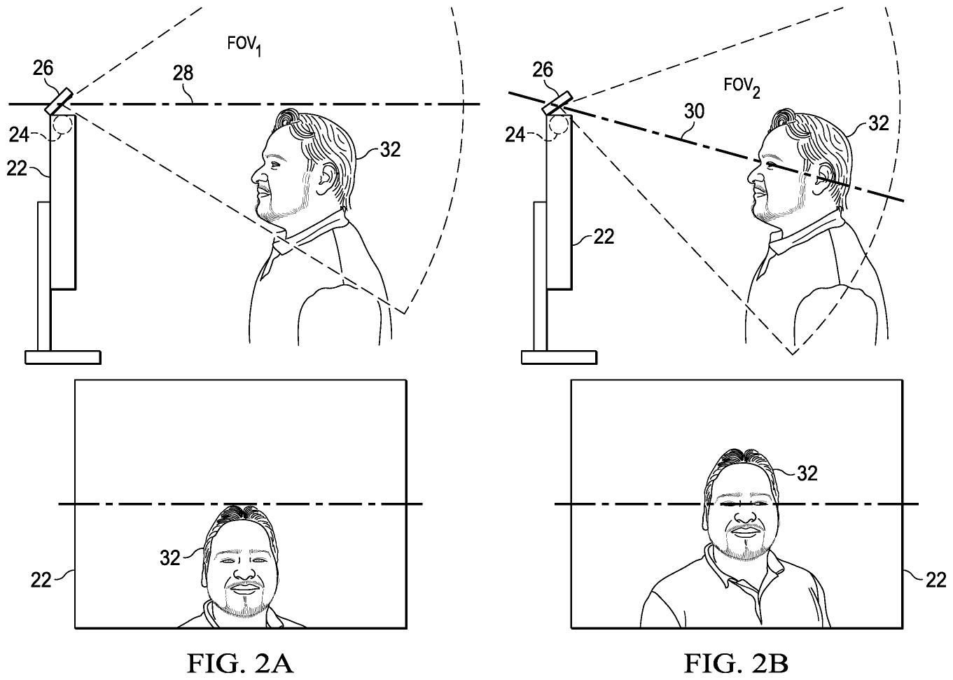

Referring now to FIGS. 2A and 2B, an example embodiment depicts selectable fields of view 28 and 30 provided by the adjustable mirror 26. FIG. 2A depicts an initial positioning of adjustable mirror 26 to an open position of substantially 45 degrees that provides a field of view 28 substantially perpendicular to the plane at which display 22 presents visual images. In the initial visual image captured by camera 24 and presented by display 22, the end user 32 is presented with his head shown in the lower half of the visual image. Based upon the presented visual image, the end user may adjust a tilt angle of adjustable mirror 26 to substantially 40 degrees, as depicted by FIG. 2B, so that end user 32 is presented at display 22 in a centered position. For each degree of the tilt angle change that is selected by the end user, the field of view is adjusted by two degrees. An automated actuator may tilt the angle of adjustable mirror 26 based upon a detected position of the end user's face so that the face remains in a centered position as the end user moves vertically relative to adjustable mirror 26, such as by standing or sitting. In the example embodiment, adjustable mirror 26 tilts between 45 and 40 degrees of angular orientation to provide 10 degrees of field of view adjustment. In an alternative embodiment, 10 degrees of mirror tilt provides 20 degrees of field of view change. The example embodiment provides the field of view adjustments with adjustable mirror 26 adjustments, however, slight changes to the vertical orientation of camera module 24 may be used to further enhance field of view changes. In the example embodiment, adjustable mirror extends up from the top side of display 22, however, in an alternative embodiment the adjustable mirror may extend out from a bottom side of display 22 with the camera module oriented to accept external light from the bottom side surface of display 22.

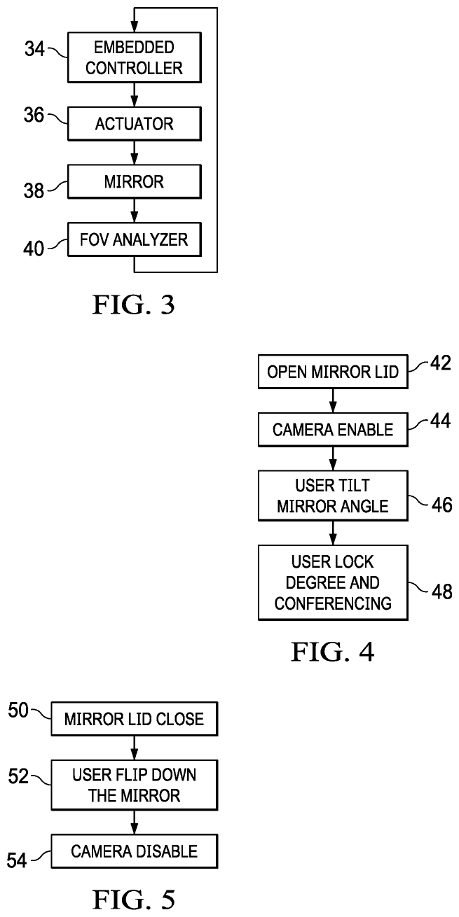

Referring now to FIG. 3, a flow diagram depicts a process for automated selection of a field of view with an actuator coupled to the adjustable mirror. At step 34 an embedded controller compares a field of view of the camera module with a desired field of view to determine an actuation of the adjustable mirror. At step 36 the actuator moves the adjustable mirror to the tilt angle commanded by the embedded controller. At step 38 the adjustable mirror changes the tilt angle in response to the actuator to change the field of view provided to the camera module. At step 40 a field of view analyzer compares the camera field of view with a desired field of view to determine an offset angle that will provide the desired field of view and provides the offset angle to the embedded controller. As an example, the field of view analyzer compares a detected facial position with a centered facial position and commands adjustment of the mirror tilt to the achieve the centered facial position.

Referring now to FIG. 4, a flow diagram depicts a process for initiation of camera use by opening the adjustable mirror. The process starts at step 42 with detection of the mirror rotated to an open position from a closed position over the camera module, such as with a switch disposed at the display proximate the mirror that opens when the mirror lifts up from the display top or detection of light by an ambient light sensor as the mirror rotates open to allow external light into the opening in which the camera module resides. At step 44 the camera module is enabled to capture visual images, such as by application of power to operate the camera module. At step 46, the end user adjusts the tilt of the adjustable mirror align with a desired field of view. At step 48, once the end user has achieved the desired field of view a lock holds the adjustable mirror at the selected tilt angle and the end user has the camera module available for use, such as perform a video conference.

Referring now to FIG. 5, a flow diagram depicts a process for securing the camera by closing the adjustable mirror. Once the end user completes the camera usage at step 50 the adjustable mirror closed position is selected to secure the information handling system from unauthorized use, such as by a malicious actor. At step 52 the user flips down the adjustable mirror to close over top of the camera module and block external light from entering the opening in the display where the camera module resides. At step 54 the camera module is disabled from capturing visual images in response to closing of the mirror.

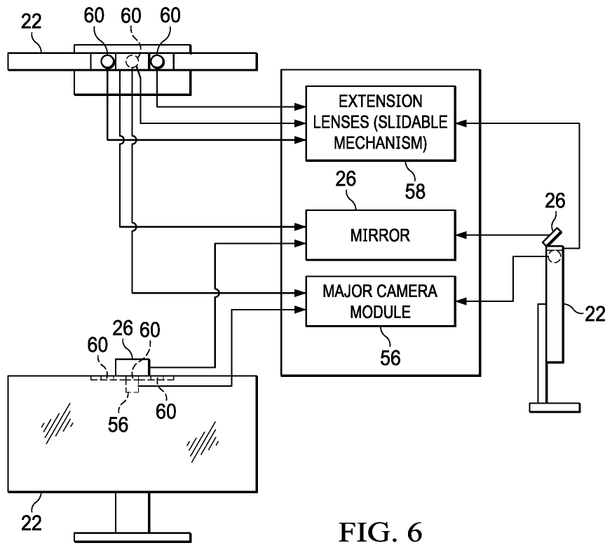

Referring now to FIG. 6, an example embodiment depicts a camera having selectable lenses 60 to adjust light that passes to the camera module 56. In the example embodiment, adjustable mirror 26 rotates between open and closed positions as describe above, however, light reflected by the adjustable mirror towards the camera module 56 passes through a lens 60 that is selected by sliding the lens into position between adjustable mirror 26 and camera module 56. In the example embodiment, an extension lens slidable mechanism 58, such as a rail that engages with lens 60, slides lenses 60 so that a selected lens aligns with camera module 56 to adjust visual images captured by the camera module, such as with different levels of zoom. The example embodiment has three lenses 60, each with a different zoom level, that slide within the display housing under the top side so that a selected lens is disposed in the opening of the display housing through which the external light passes to the camera module 56.

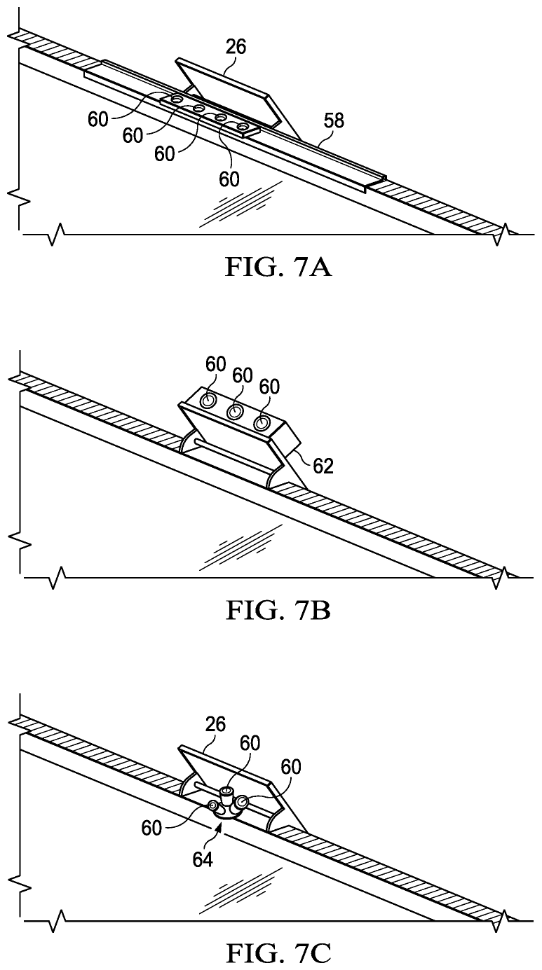

Referring now to FIGS. 7A, 7B and 7C, alternative embodiments are depicted for adjusting light directed to a camera by selectable lens that couple to the display proximate the mirror. FIG. 7A depicts a slidable mechanism 58, such as a rail having lenses 60 that slide relative to the underlying camera module as described above. FIG. 7B depicts an alternative embodiment having a flippable mechanism that rotates from a stored position as the rear of the adjustable mirror to an engage position between the adjustable mirror and the camera module. Lenses 60 in the flippable mechanism adjust light that is directed to the camera module, such as for providing different levels of zoom. A lens 60 may adjust light before the light reflects off adjustable mirror 26 or may adjust light after reflection from the mirror as the light proceeds through the lens and towards the camera module. FIG. 7C depicts an alternative embodiment having a rotatable base 64 that rotates each of plural selectable lenses 60 into alignment with the camera module to provide different levels of zoom. The example embodiment depicts a rotatable base 64 that fits over the opening in the display housing and rotates each lens 60 in alignment as selected by an end user. In an alternative embodiment, rotatable base 64 fits inside the display housing and has an external lens selector that the end user can manipulate to select a lens for alignment. In one embodiment, the adjustable mirror may have a curved shape, such as an elliptical or parabolic shape, that helps to focus external light for passage through the lenses.

Although the present invention has been described in detail, it should be understood that various changes, substitutions and alterations can be made hereto without departing from the spirit and scope of the invention as defined by the appended claims.

1. An information handling system comprising:
a housing;
a processor disposed in the housing and operable to execute instructions;
a memory disposed in the housing and interfaced with the processor, the memory operable to store the instructions and information;
a display interfaced with the processor and operable to present the information as visual images;
a camera coupled to the display, the camera having a camera module aligned to capture light along a first axis parallel to a plane of the display and directed from a range of angles about an axis perpendicular to the plane of the display by a mirror coupled at a side of the display, the mirror having a closed position that blocks the light from the camera module and a selectable open position that directs the light to the camera module from the range of angles;
plural lens associated with the camera; and
a lens selector operable to align a selected of the plural lens from a rear of the mirror to a position to adjust the visual image captured at the camera module.

2. The information handling system of claim 1 wherein:
the mirror rotationally couples to a top side of the display;
the closed position rotates the mirror flat against the top side of the display to cover the camera module; and
the open position rotates the mirror from flat against the display to a position above the display.

3. The information handling system of claim 2 wherein:
the mirror rotates about an axis at the rear side of the display; and
the range of angles comprises a 45 degree mirror tilt to capture light perpendicular to the plane of the display.

4. The information handling system of claim 1 wherein the lens selector aligns the lens and mirror to adjust light before the light reflects from the mirror towards the camera module.

5. The information handling system of claim 1 wherein the lens selector aligns the lens and mirror to adjust light after the light reflects from the mirror and before the light enters the camera module.

6. (canceled)

7. (canceled)

8. The information handling system of claim 2 further comprising:
an actuator coupled to the mirror and operable actuate the mirror to direct light to the camera module through at least the range of angles; and
a controller interfaced with the actuator and operable to command actuation of the mirror to maintain a visual image captured by the camera module at a predetermined position.

9. The information handling system of claim 1 wherein:
the mirror rotationally couples to a bottom side of the display;
the closed position rotates the mirror flat against the bottom side of the display to cover the camera module; and
the open position rotates the mirror from flat against the display to a position below the display.

10. A method for capturing visual images at an information handling system display, the method comprising:
coupling a mirror to the display top side surface and over a camera module to block external light from the camera module;
rotating the mirror about an axis at the rear side of the display to raise the mirror above the camera module with an angular offset relative to the display top surface;
reflecting light from a front side of the display with the mirror towards the camera module to capture visual images;
coupling one or more lenses to a rear side of the mirror; and
rotating the one or more lenses to a front side of the mirror to adjust light passing to the camera module.

11. The method of claim 10 further comprising:
rotating the mirror about the axis to adjust the angular offset within a range of angles; and
reflecting the light from the front side of the display at the adjusted angular offset to adjust the axis at which visual images are captured by the camera module.

12. The method of claim 10 wherein the lens selector aligns the lens and mirror to adjust light before the light reflects from the mirror towards the camera module.

13. The method of claim 10 wherein the lens selector aligns the lens and mirror to adjust light after the light reflects from the mirror and before the light enters the camera module.

14. (canceled)

15. The method of claim 11 further comprising:
interfacing an actuator with the mirror;
monitoring visual images captured by the camera module; and
in response to the monitoring actuating the mirror to adjust the angular offset to manage a position of the visual images captured by the camera module.

16. The method of claim 15 further comprising:
closing the mirror against the display top surface to block external light from the camera module; and
in response to closing, powering off the camera module.

17. A peripheral display comprising:
a display housing;
a display panel coupled at a front side of the display housing and operable to present visual images; and
a camera module coupled in the display housing at the rear side of the display panel and aligned to capture visual images along a vertical axis through an opening in an upper side of the display housing;
a mirror rotationally coupled at a rear side of the display housing proximate the opening in the upper side and configured to rotate between a closed position to cover the opening and an open position tilted to reflect light from the front side of the display housing into the opening and at the camera module; and
a lens rotationally coupled to a rear side of the mirror and configured to flip to a front side of the mirror to adjust light reflected by the mirror to the camera module.

18. The peripheral display of claim 17 wherein the lens selector aligns the lens and mirror to adjust light before the light reflects from the mirror towards the camera module.

19. The peripheral display of claim 17 wherein the lens selector aligns the lens and mirror to adjust light after the light reflects from the mirror and before the light enters the camera module.

20. (canceled)
